(19) United States
(12) Patent Application Publication
(10) Pub. No.: US 2016/0195837 A1
(43) Pub. Date: Jul. 7, 2016

(54) IMAGE FORMING APPARATUS

(71) Applicant: CANON KABUSHIKI KAISHA, Tokyo (JP)

(72) Inventor: Taisuke Matsuura, Toride-shi (JP)

(21) Appl. No.: 15/067,335

(22) Filed: Mar. 11, 2016

Related U.S. Application Data
(63) Continuation of application No. PCT/JP2014/075763, filed on Sep. 19, 2014.

(30) Foreign Application Priority Data
Sep. 19, 2013 (JP) 2013-194576

(51) Int. Cl. G03G 15/16

(52) U.S. Cl. CPC G03G 15/1675

(57) ABSTRACT

An image forming apparatus (20) includes a primary transfer means (5) for primary-transferring a toner image, formed by a developing means (4), at a primary transfer position (N1) between an intermediary transfer belt (7) and an image bearing member (1). Further, the image forming apparatus includes a rotatable secondary transfer member (8) to which a secondary transfer bias is applied between itself and a rotatable driving member so as to secondary-transfer the toner image, primary-transferred on the intermediary transfer belt, onto a recording material (P) fed to a secondary transfer position (N2). Further, the image forming apparatus includes a control means (12) for starting application of the secondary transfer bias between start of exposure by an exposure means (3a) and before the toner image formed by this exposure reaches the primary transfer position.

### TECHNICAL FIELD

The present invention relates to an image forming apparatus, such as a printer or a copying machine, using an electrophotographic type or an electrostatic recording type.

### BACKGROUND ART

Conventionally, there are various image forming apparatuses employing the electrophotographic type and the electrostatic recording type in an image forming process, and in these image forming apparatuses, the following types exist. As one thereof, a tandem type image forming apparatus in which a plurality of process cartridges arranged in line along an intermediary transfer belt are provided detachably mountable to an image forming apparatus main assembly and in which the image forming apparatus is constituted so as to form a full-color image exists.

In such a tandem type image forming apparatus, a constitution in which rollers for stretching the intermediary transfer belt are made smaller in diameter and the number of rubber rollers high in cost is made small has been known. The rubber rollers using EPDM or the like as a material are high in cost, and therefore in this constitution, an opposite roller (inner secondary transfer roller) to a secondary transfer roller (outer secondary transfer roller) is made the same as a driving roller for driving the intermediary transfer belt, so that the rollers are unified into a single roller. By this, the number of the rubber rollers used in an intermediary transfer belt unit is reduced.

In Japanese Laid-open Patent Application Hei 2-123385, an ATVC control type in which a voltage is applied to a transfer portion in advance of image formation (print) and a current flowing through a transfer roller is measured and in which a voltage condition used at a transfer portion during the image formation is set is employed. Or, a PTVC control type in which a value of a current flowing through a transfer member under application of a constant voltage to a transfer portion where a recording material (sheet) is not passed is measured and voltage-current data at a plurality of stages are subjected to interpolation computation and thus a constant voltage used during image formation is set is employed. Incidentally, an image forming apparatus in which, in addition to commonality of the inner secondary transfer roller and the driving roller as described above, this roller is made small in size and is compactified has been known. In this image forming apparatus, a frictional force between the small-diameter driving roller and the intermediary transfer belt becomes small, so that there is a possibility that a slip generates between the driving roller and the intermediary transfer belt. Further, also in the case where a tension force for stretching the intermediary transfer belt is small, there is a possibility that a feeding force of the intermediary transfer belt lowers.

Here, when a transfer bias is applied to a primary transfer roller, a photosensitive drum and the intermediary transfer belt generate an electrostatic attraction force and are strongly in intimate contact with each other. At this time, when the small-diameter driving roller is contaminated with a toner and a frictional force lowers and thus a feeding force of the intermediary transfer belt lowers, the electrostatic attraction force exceeds the feeding force, so that the intermediary transfer belt and the driving roller slip with each other. As a result thereof, the intermediary transfer belt set to have a difference in speed with the photosensitive drum is not fed at a rotational speed of the driving roller, so that there is a possibility that the intermediary transfer belt is fed at a rotational speed of the photosensitive drum.

Further, the frictional force, generated by the electrostatic attraction force between the photosensitive drum and the intermediary transfer belt, generating when the transfer bias is applied to the primary transfer roller becomes small, in the case where toner particles exist on the photosensitive drum, by the action of the toner particles as a friction-lowering agent. For that reason, in the case of full-color printing, the frictional force between the photosensitive drum and the intermediary transfer belt is large until a toner image for a first color in print of a first sheet reaches a primary transfer nip, but becomes small when the toner image reached the primary transfer nip. Also when there is no toner image for the first color at the primary transfer nip, the frictional force becomes small when the toner particles exist at any of the primary transfer nips for four colors, such as when toner images for a second color and later subsequently to the toner image for the first color reach the respective primary transfer nips or in the case of full colors on a second sheet and later in a continuous job. Due to these, before and after start of primary transfer for the first color, a difference of the rotational speed of the intermediary transfer belt relative to the rotational speed of the photosensitive drum generates. By such a phenomenon, there is a liability that on the intermediary transfer belt, color misregistration generates with respect to a sub-scan direction which is a feeding direction of the image.

Further, similarly as the primary transfer roller, also in the case where a secondary transfer bias is applied to the secondary transfer roller (outer secondary transfer roller), between the driving roller (inner secondary transfer roller) which is its opposite roller and the intermediary transfer belt, the frictional force due to the electrostatic attraction force generates.

In the case where the driving roller is small in diameter and the feeding force of the intermediary transfer belt is relatively weak as described above, even in the case where the color misregistration generates by the electrostatic attraction force between the photosensitive drum and the intermediary transfer belt, the generation of the color misregistration can be prevented in some cases by applying a bias for the secondary transfer roller. That is, by the electrostatic attraction force, the frictional force between the driving roller and the intermediary transfer belt is made higher than the electrostatic attraction force between the photosensitive drum and the intermediary transfer belt, the generation of the color misregistration is prevented.

The above-described color misregistration is liable to generate due to a lowering in frictional force between the photosensitive drum and the intermediary transfer belt when the toner image for the first color relating to the print of the first sheet in the case where there are no toner particles on the photosensitive drums for the second color and later.

Usually, the secondary transfer bias is applied immediately before the recording material reaches a secondary transfer nip, but it would be considered that the secondary transfer bias is applied when the toner image for the first color relating to the first sheet reaches the primary transfer nip and the frictional force between the driving roller and the intermediary transfer belt is enhanced. In this case, the frictional force by the driving roller is enhanced, so that effective prevention of the color misregistration becomes possible.

In that case, when the toner image for the first color relating to the first sheet reaches the primary transfer nip, the above-described PTVC is executed, with the result that the frictional force between the driving roller and the intermediary transfer belt is in a high state and thus the generation of the color misregistration can be prevented in some instance. A state at this time is schematically shown in a time chart of FIG. 10.

That is, as shown in FIG. 10, similarly as in the case where the toner image for the first color relating to the first sheet reaches the primary transfer nip, also in the print of the second sheet and later, when the toner image for the first color reaches the primary transfer nip, the secondary transfer bias is applied. Or, the toner particles as the friction-lowering agent are placed on the photosensitive drums for the second color and later, and therefore the generation of the color misregistration can be prevented in some cases.

In a sheet (paper) interval G during continuous print or the like, the secondary transfer bias is turned off or a potential of the same polarity as the toner is applied, but that is for the following reason. That is, an ion conductive material is principally used for the transfer roller and suppresses a rise of a resistance value of the transfer roller and thus prevents a short lifetime of the transfer roller, and therefore in the sheet interval G, the secondary transfer bias is turned off or the potential of the same polarity as the toner is applied.

In the case of the transfer roller using the ion conductive material, localization of an ion component generates by energization and the resistance value increases, and therefore even in the sheet interval G, when the bias is continuously applied, a roller lifetime becomes short. For this reason, in the sheet interval G, the secondary transfer bias is turned off or the potential of the same polarity as the toner is applied. Accordingly, when the sheet interval G increases by consumption of much time for image adjustment or image processing, when the toner image for the first color reaches the primary transfer nip, the secondary transfer bias is not applied in some cases. Here, “the sheet interval increases” means the case where the sheet interval exceeds a normal sheet interval (for example, with respect to an A4-sized recording material, 30 mm in length and 150 msec in time) during the continuous print.

A state of the case where the sheet interval G increases is schematically shown in time chart of FIG. 11. That is, as shown in FIG. 11, in the case where the sheet interval G increases, when the toner image for the first color reaches the primary transfer nip, the secondary transfer bias as an image forming bias is not applied. At this time, the toner particles as the friction-lowering agent are not placed on also the photosensitive drums for the second color and later, and therefore a possibility that the color misregistration generates becomes high.

On the other hand, the primary transfer bias is not turned off in the sheet intervals during continuous sheet passing but application is continued. This is for the following reason. That is, a surface potential of the photosensitive drum lowers by application of the primary transfer bias, and therefore between a position where the primary transfer bias is applied and a position where the primary transfer bias is not applied, the surface potential of the photosensitive drum changes. For that reason, in order to provide the surface potential of the photosensitive drum with a certain value, the primary transfer bias is continuously applied during the sheet interval.

Further, in a sheet interval of a normal interval, together with drive of a developing sleeve and a bias obtained by superposing a direct current bias (DC bias) and an alternating current bias (AC bias), also a developing bias is still in an on state. However, in the case where the sheet interval increases, only the DC bias is continuously applied in order to maintain a potential difference with the photosensitive drum, but the drive of the developing sleeve and the application of the AC bias are usually turned off in order to prevent deterioration of the developer. A fog toner does not generate when the AC bias is not applied, but also this tog toner lowers, as the friction-lowering agent, the frictional force between the intermediary transfer belt and the photosensitive drum similarly as the toner in an image forming region.

### SUMMARY OF THE INVENTION

According to an aspect of the present invention, there is provided an image forming apparatus comprising: a photosensitive member rotationally moving at a predetermined peripheral speed; an exposure unit for forming a latent image by subjecting the photosensitive member electrically charged to image exposure on the basis of an linage signal; a developing unit for depositing a toner image on the latent image formed on the photosensitive member; an intermediary transfer belt, moving at a different peripheral speed from the photosensitive member, onto which the toner image on the photosensitive member is once transferred at a primary transfer portion contacting the photosensitive member; a transfer member for transferring the toner image, transferred on the intermediary transfer member, onto a recording material at a secondary transfer portion; a transfer voltage source for applying a secondary transfer bias to the secondary transfer portion; and a controller for controlling, in a recording material interval from passing of a trailing end of a certain recording material through the secondary transfer portion to passing of a leading end of a subsequent recording material through the secondary transfer portion during execution of continuous image formation, the transfer voltage source so that application of the secondary transfer bias is started at timing of either one of first timing and second timing which are before the application of the secondary transfer bias is stopped or a bias of an opposite polarity to the secondary transfer bias is started after the passing of the trailing end of the certain recording material through the secondary transfer portion and then the leading end of the subsequent recording material reaches the secondary transfer portion, wherein the controller controls the transfer voltage source every recording material interval at the first timing in a case where a time of the recording material interval is less than a predetermined time and at the second timing in a case where the time of the recording material interval is not less than the predetermined time, and wherein the first timing is timing immediately before the toner image corresponding to the image exposure reaches the secondary transfer portion, and the second timing is timing from start of the image exposure until the toner image corresponding to the image exposure reaches the primary transfer portion.

### BRIEF DESCRIPTION OF THE DRAWINGS

FIG. 1 is a schematic sectional view showing an entirety of an image forming apparatus according to the present invention.

FIG. 2 is a schematic sectional view showing a part of the image forming apparatus according to First Embodiment of the present invention.

FIG. 3 is a schematic sectional view showing a degree of a winding angle (winding angle) between an intermediary transfer belt and a driving roller.

FIG. 4 is a schematic sectional view showing an image writing position and a primary transfer as portion and the like.

FIG. 5 is a flowchart for illustrating the action in First Embodiment.

FIG. 6 is a time chart showing a state of a sheet interval during image formation in First Embodiment.

FIG. 7 is a time chart showing application timing of a secondary transfer bias in First Embodiment.

FIG. 8 is a schematic sectional view showing a part of an image forming apparatus in Second Embodiment of the present invention.

FIG. 9 is a flowchart for illustrating the action in Second Embodiment.

FIG. 10 is a time chart showing a state of a sheet interval of a normal interval during image formation.

FIG. 11 is a time chart showing a state in which the sheet interval exceeds the interval during normal (sheet interval) and increases.

### EMBODIMENTS FOR CARRYING OUT THE INVENTION

### First Embodiment

In the following, an embodiment of an image forming apparatus 20 according to the present invention will be described with reference to the drawings. Incidentally, throughout the respective drawings, the same symbols show the same or corresponding portions. As the image forming apparatus, it is possible to cite those of a plurality of species employing an electrophotographic type, an offset printing type, an ink jet type, and the like.

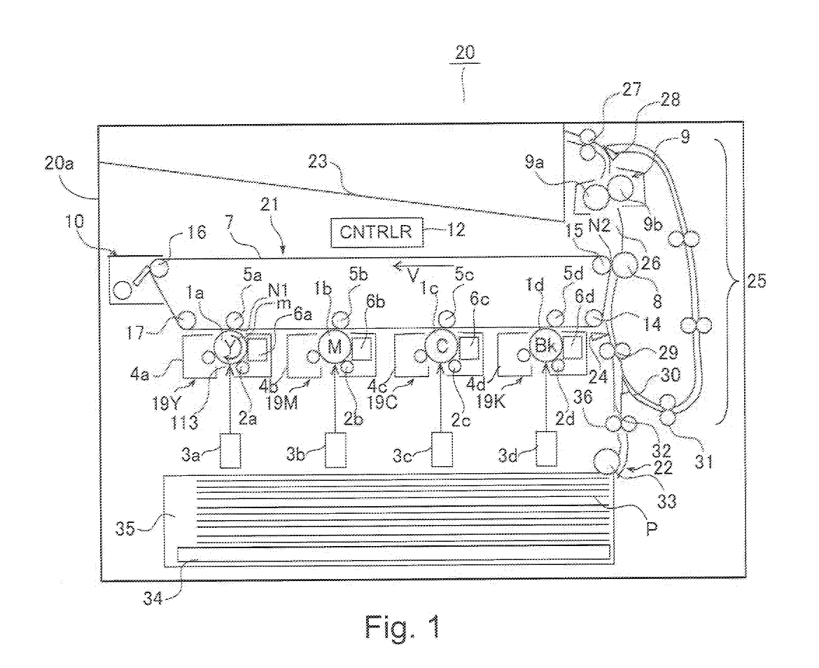

The image forming apparatus 20 shown in FIG. 1 uses the electrophotographic type and employs a so-called intermediary transfer tandem type in which image forming portions for four colors are arranged and disposed on an intermediary transfer belt 7 as a rotatable endless belt. This intermediary transfer tandem type goes mainstream in recent years from the viewpoint that it is excellent in thick paper compatibility and productivity.

As shown in FIG. 1, the image forming apparatus 20 includes an apparatus main assembly 20a, and includes a controller (control portion) 12 as a control means in the apparatus main assembly 20a. The image forming apparatus 20 is constituted so that an image forming operation is performed depending on input image information from an external host device (not shown in the figure) communicatably connected with the controller 12 and a full-color image is formed and outputted on a recording material. The external host device means a computer, an image reader or the like.

The apparatus main assembly 20a includes image forming portions 19Y, 19M, 19C, 19K, a recording material accommodating portion 35 provided in and at a lower portion of the apparatus main assembly 20a, a feeding portion 22, and a discharge tray 23 provided at an upper portion of the apparatus main assembly 20a. On a life-up device 34 in the recording material accommodating portion 35, many recording materials P are accommodated in a stacked state. Sheet-like recording materials P are fed (sent) in synchronism with image formation timing by a sheet feeding roller 33 of the feeding portion 22 disposed at an upper portion on a downstream side with respect to a recording material feeding direction (left-right direction of FIG. 1). Incidentally, a feeding type is not limited to this, but it is also possible to use another type.

Above the image forming portions 19Y-19K, an intermediary transfer belt unit 21 including the endless and flexible intermediary transfer belt 7 is disposed. The intermediary transfer belt 7 is extended around and stretched by an inner secondary transfer roller 15, a tension roller 16 and stretching rollers 14, 17, and is rotationally driven in the counterclockwise direction (arrow V direction) of FIG. 1 at predetermined speed by drive of the inner secondary transfer roller 15.

The recording material P sent from the inside of the recording material accommodating portion 35 by the feeding roller 33 passes through a sheet feeding path 32 to a registration roller pair 29. The recording material P is subjected to oblique movement correction or timing correction by the registration roller pair 29, and thereafter is sent to a secondary transfer portion. Immediately downstream of the registration roller pair 29, a recording material detecting sensor 24 is disposed. The recording material detecting sensor 24 detects a leading end and a trailing end of the recording material sent from the registration roller pair 29 and sends a detection signal thereof to the controller 12. The controller 12 received the detection signal checks a sending state of the recording material P to a secondary transfer nip N2 and detects an interval (sheet interval) between recording materials during continuous printing or the like.

The secondary transfer portion is consisting of the secondary transfer nip N2 formed by the inner secondary transfer roller 15 also functioning as a driving roller 15 and an outer secondary transfer roller 8 which are opposed to each other. The inner secondary transfer roller 15 constitutes a rotatable driving member which rotates in in which it stretches the intermediary transfer belt 7 and which rotationally drives the intermediary transfer belt 7. Then, a predetermined pressure (pressing force) and a predetermined electrostatic load bias (secondary transfer bias) are applied to this secondary transfer portion, so that toner images on the intermediary transfer belt are secondary-transferred onto the recording material.

The outer secondary transfer roller 8 contacts the intermediary transfer belt 7 at the secondary transfer nip (secondary transfer position) N2 opposing the inner secondary transfer roller 15. The outer secondary transfer roller 8 constitutes a rotatable secondary transfer member to which the secondary transfer bias is applied between itself and the inner secondary transfer roller 15 as a rotatable driving member so that the toner images primary-transferred on the intermediary transfer belt 7 are secondary-transferred onto the recording material P fed to the secondary transfer nip N2.

Next, relative to a feeding process of the recording material P to the secondary transfer portion described above, am image forming process, until the secondary transfer portion, performed at similar timing will be described.

The image forming apparatus 20 includes 4 stations of the image forming portion 19Y, the image forming portion 19M, the image forming portion 19C and the image forming portion 19K, and these 4 image forming portions are disposed in line at certain intervals. The image forming portion 19Y forms an image with a toner of yellow (Y), the image forming portion 19M forms an image with a toner of magenta (M), the image forming portion 19C forms an image with a toner of cyan (C), and the image forming portion 19K forms an image with a toner of black (Bk). The image forming portion 19Y, the image forming portion 19M, the image forming portion 19C and the image forming portion 19K include a similar constitution except that the colors of the toners are different from each other.

The image forming portions 19Y, 19M, 19C, 19K include photosensitive drums 1a, 1b, 1c, 1d as rotating image bearing members, charging rollers 2a, 2b, 2c, 2d for electrically charging the photosensitive drums 1a-1d, respectively, and exposure devices 3a, 3b, 3c, 3d, respectively. These exposure devices 3a-3d charge exposure means for exposing the charged photosensitive drums 1a-1d, respectively, to light to form latent images.

Further, the image forming portions 19Y-19K include developing devices 4a, 4b, 4c, 4d, primary transfer rollers 5a, 5b, 5c, 5d, and photosensitive member cleaners 6a, 6b, 6c, 6d, respectively. The developing devices 4a-4d constitute developing means for developing respective latent images formed on the photosensitive drums 1a-1d into toner images by application of a developing bias. The primary transfer rollers 5a-5d constitute primary transfer means for primary-transferring the toner images formed by the developing devices 4a-4d from the photosensitive drum 1a-1d onto the intermediary transfer belt 7 at the primary transfer nips (primary transfer positions) N1 between the intermediary transfer belt 7 and the photosensitive drums 1a-1d.

The photosensitive drums 1a, 1b, 1c, 1d rotating in an arrow m direction in FIG. 1 are uniformly charged at surfaces thereof by the charging rollers 2a, 2b, 2c, 2d, respectively. Then, when laser light modulated depending on an image signal is outputted from the exposure devices 3a-3d including a laser and a polygon mirror correction system lens, this laser light is reflected by a reflection mirror and each of the charged photosensitive drums 1a-1d is exposed thereto, so that electrostatic latent images are formed. The electrostatic latent images formed on the photosensitive drums 1a-1d, respectively, are developed by the developing devices 4a-4d, and are formed as toner images for the respective colors on the photosensitive drums 1a-1d.

Thereafter, by the primary transfer rollers 5a-5d to which a predetermined pressure and a predetermined electrostatic load bias are applied, the toner images of the respective colors are successively transferred onto the intermediary transfer belt 7. Thereafter, transfer residual toners remaining on the photosensitive drums 1a-1d, respectively, are collected by the photosensitive member cleaners 6a-6d, so that the image forming apparatus prepares for subsequent image formation again.

As the image forming portions 19Y, 19M, 19C, 19K described above, in the case of FIG. 1, 4 sets for yellow (Y), magenta (M), cyan (C), black (Bk) are disposed. For this reason, the toner image of magenta formed at the image forming portion 19M is transferred onto the intermediary transfer belt 7 so as to correspond to the toner image of yellow formed on the intermediary transfer belt 7. Further, the toner image of cyan formed at the image forming portion 19C is transferred onto the intermediary transfer belt 7 so as to correspond to the formed toner image of magenta. Further, the toner image of black formed at the image forming portion 19K is transferred onto the intermediary transfer belt 7 so as to correspond to the toner image of cyan.

In this way, the toner images of different colors are successively formed superposedly onto the intermediary transfer belt 7, whereby a full-color image is formed on the intermediary transfer belt 7. Incidentally, the number of the colors in this embodiment was 4 (colors), but the number of the colors is not limited to 4, and also the order of arrangement of the colors is not limited to this.

Subsequently, referring to FIG. 1, details of the intermediary transfer belt 7 will be described. That is, the intermediary transfer belt 7 is stretched by the inner secondary transfer roller 15 also functioning as the driving roller as the rotatable driving member, the tension roller 16 for imparting a predetermined tension (tension force) to the intermediary transfer belt 7, and the stretching rollers 14, 17. The intermediary transfer belt 7 is constituted so as to rotate (be fed and driven) in the arrow V direction in FIG. 1.

The image forming processes for the respective colors subjected to parallel processing by the above-described image forming portions 19Y, 19M, 19C, 19K, respectively, are performed at timing when the toner image is superposed on the toner image of an upstream color primary-transferred on the intermediary transfer belt 7. As a result, finally, the full-color toner image is formed on the intermediary transfer belt and is fed to the secondary transfer nip (secondary transfer portion) N2. Incidentally, the number of the rollers for stretching the intermediary transfer belt 7 is not limited to that in the constitution of FIG. 1.

### Process of Secondary Transfer and Later

As described above, by the feeding process of the recording material P and the image forming process which are explained, the full-color toner image formed on the intermediary transfer belt 7 is secondary-transferred onto the recording material P at the secondary transfer portion.

Thereafter, this recording material P is fed to a fixing device 9 via a pre-fixing portion 26. For the fixing device 9, there are various constitutions and types, but the fixing device 9 shown in FIG. 1 is of the type in which the toner image is melt-fixed on the recording material under application of predetermined pressure and predetermined hat quantity in a fixing nip formed by a fixing roller 9a and a pressing roller 9b which are opposed to each other.

In the fixing device 9, the fixing roller 9a includes therein a heater as a heating source, and the pressing roller 9b is urged toward the fixing roller 9a. The recording material P which passes through the fixing device 9 and which is fed to a discharging and reversing roller 27 is subjected to route selection of whether it is discharged onto the discharge tray 23 or is guided by a branching device 28 and fed to a double-surface feeding path 25 in the case where double-surface image formation is needed. In the case where the double-surface image formation is needed, the recording material P is replaced between a leading end and a trailing end by performing a switch-back operation by the discharging and reversing roller 27, and is fed to the double-surface feeding path 25.

Thereafter, the recording material P replaced between the leading and trailing ends is merged from a re-sheet feeding path 30 into the sheet feeding path 32 in synchronism with timing of the recording material fed by the sheet feeding roller 33 in a subsequent job, and is sent to the secondary transfer portion similarly as described above. The image forming process oil a back surface (second surface) is similar to that during the printing on the above-described front surface (first surface), and therefore description will be omitted. The toner remaining on the intermediary transfer belt 7 without being secondary-transferred onto the recording material P is removed by an intermediary transfer belt cleaner 10 contacting the intermediary transfer belt 7.

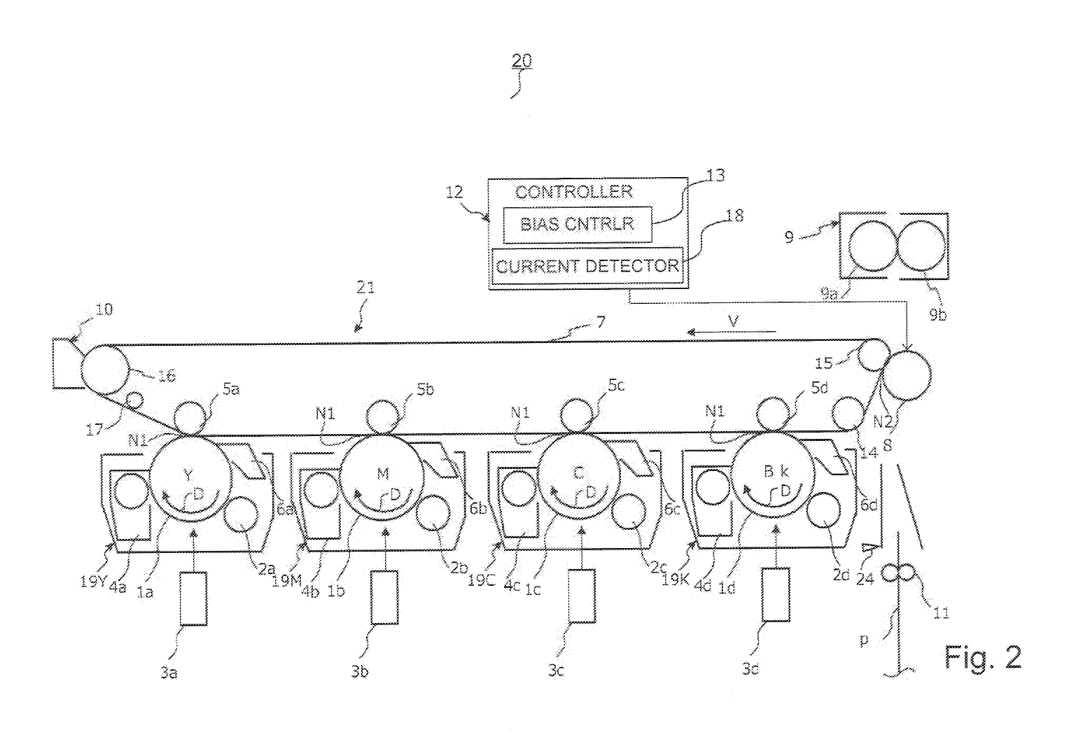

Next, with reference to FIG. 2, constitutions and operations of portions including the intermediary transfer belt unit 21 and the image forming portions 19Y-19K and the like in the image forming apparatus 20 will be described in detail. Incidentally, FIG. 2 is a schematic sectional view showing a part of the image forming apparatus 20 in this embodiment.

As shown in FIG. 2, the controller 12 provided in the apparatus main assembly 20a (see FIG. 1) of the image forming apparatus 20 not only includes unshown ROM, RAM and memory but also includes a bias control means 13 and a transfer current detecting means 18. On the basis of a detection signal received from the recording material detecting sensor 24, the controller 12 checks a sending state of the recording material P to the secondary transfer nip N2 or detects an interval (sheet interval) between recording materials during continuous printing or the like.

The bias control means 13 controls an unshown voltage source, so that a primary transfer bias is applied between the primary transfer rollers 5a-5d and the photosensitive drums 1a-1d, and a secondary transfer bias is applied between the outer secondary transfer roller 8 and the inner secondary transfer roller 15.

The transfer current detecting means 18 detects each of transfer currents flowing between the primary transfer rollers 5a-5d and the photosensitive drums 1a-1d and detects a transfer current flowing between the outer secondary transfer roller 8 and the inner secondary transfer roller 15. When PTVC control is executed, the transfer current detecting means 18 detects a current flowing through the primary transfer nips (primary transfer portions) N1 under application of a voltage to the primary transfer rollers 5a-5d in advance of image formation in order to set a voltage condition used during the primary transfer.

The controller 12 as a control means starts application of the secondary transfer bias by the bias control means is between from start of the exposure by the exposure device 3a as an exposure means and before the toner image formed by this exposure readies the primary transfer nip (primary transfer position) N1. That is, the controller 12 is constituted so as to be capable of switching a first mode and a second mode below. In this embodiment, the controller 12 effects the switching between the first mode and the second mode depending on the interval between recording materials fed to the secondary transfer nip (secondary transfer position) N2. For this reason, the controller 12 is capable of accurately switching the first mode and the second mode correspondingly to the interval between recording materials based on the detection signal of the recording material detecting sensor 24.

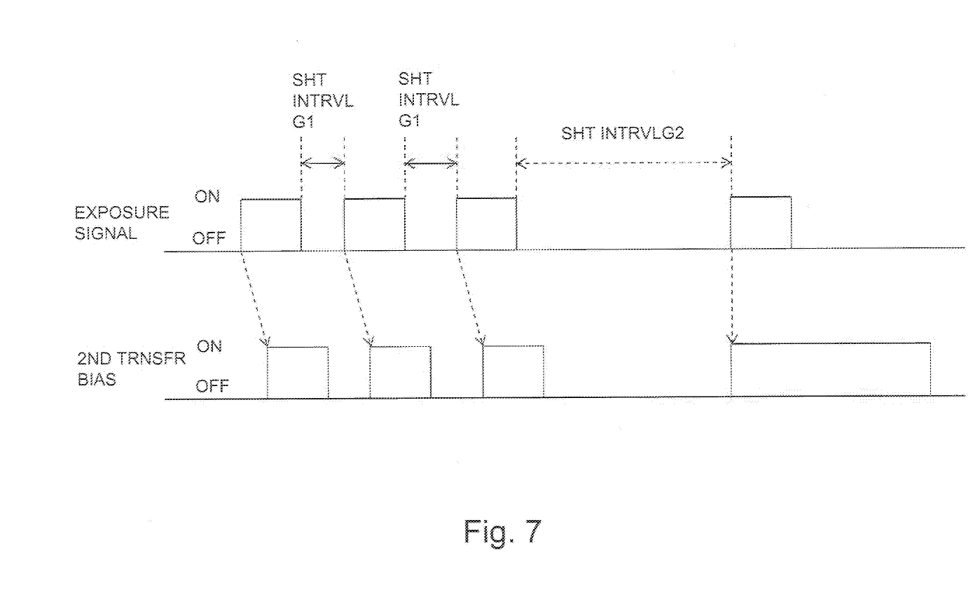

The first mode is a mode in which the application of the secondary transfer bias is started between from the start of the exposure by the exposure device 3a and before the toner image formed by this exposure reaches the primary transfer nip N1. In this embodiment, in the first mode, the secondary transfer bias is applied at timing of the start of the exposure of the exposure device 3a (see FIG. 7).

The second mode in which the application of the secondary transfer bias is started immediately before the toner image formed by the exposure reaches the secondary transfer nip N2.

The controller 12 can also effect control so that the above-described PTVC control which is control for determining the secondary transfer bias is not effected in advance of the start of the image formation. In the case where this control is executed, the application of a normal secondary transfer bias which is not the PTVC control can be carried out from the time of printing on a first recording material (first sheet) after start of a job, so that even in the case where the sheet interval exceeds the interval during normal (sheet interval) and increases, it is possible to prevent generation of the color misregistration or the like from the first sheet with high reliability.

In the image forming apparatus 20 including the constitution described above, on the basis of control by the bias control means 13 of the controller 12, a primary transfer high voltage is applied to the primary transfer rollers 5a-5d. By this, the toner images for the respective colors formed by the electrophotographic process on the driven photosensitive drums 1a-1a, respectively, are successively transferred superposedly onto the intermediary transfer belt rotationally driven.

Then, on the basis of the control by the bias control means 13 of the controller 12, a secondary transfer high voltage is applied to the outer secondary transfer roller 8. By this, onto the recording material P fed by the sheet feeding roller 33 to the secondary transfer nip N2, the toner image on the intermediary transfer belt is secondary-transferred.

Thereafter, the recording material P separated from the secondary transfer nip N2 which is the secondary transfer portion is subjected to pressure-melting and fixing of the full-color toner image at the fixing nip between the fixing roller 9a and the pressing roller 9b of the fixing device 9, so that the recording material P is discharged to an outside of the machine (image forming apparatus). The toner which is not completely transferred at the secondary transfer portion is removed by the belt cleaner 10.

Here, the image forming portions 19Y-19K are constituted substantially identical to each other except that the colors of the toners used in the attached developing devices 4a-4d are yellow, magenta, cyan, black which are different from each other. In the following, the image forming portion 19Y will be described with reference to FIG. 2, and other image forming portions 19M, 19C, 19K are described by reading a suffix a of symbols of the respective portions in the described as b, c, d.

That is, as shown in FIG. 2, the image forming portion 19Y includes, at a periphery of the photosensitive drum 1a, the charging roller 2a, the exposure device 3a, the developing device 4a, the primary transfer roller 5a and the photosensitive member cleaner 6a.

The photosensitive drum 1a is rotated in an arrow D direction in a state in which an organic photoconductor layer (OPC) having a charging polarity which is a negative polarity is provided on an outer peripheral surface of ah aluminum-made cylinder of, for example, φ 30 mm in diameter.

The charging roller 2a is formed by coating a resistive elastic layer on a surface of a metallic center shaft and is forced to rotate (passive rotation) in a press-contacted state to the photosensitive drum 1a. The bias control means 13 of the controller 12 controls the voltage source, so that a DC voltage superposed with an AC voltage is applied as a charging bias to the charging roller 2a, and the surface of the photosensitive drum 1a is charged to a uniform potential of the negative polarity.

The exposure device 3a scans the photosensitive drum surface, through a rotating mirror (not shown in the figure), with a laser beam obtained by subject scanning line image data developed from a yellow separated-color image to ON-OFF modulation, so that an electrostatic image for an image is written on the surface of the charged photosensitive drum 1a.

The developing device 4a stirs a two-component developer in which a non-magnetic toner is mixed with a magnetic carrier, so that the non-magnetic toner and the magnetic carrier are charged to the negative polarity and the positive polarity, respectively. Then, by control of the voltage source by the bias control means 13 of the controller 12, a developing voltage in the form of a DC voltage (DC bias) of the negative polarity superposed with an AC voltage (AC bias) is applied to the developing sleeve. By this, the charged two-component developer is moved to the exposed portion of the photosensitive drum 1a which is positive relative to the developing sleeve, and reversely develops the electrostatic image.

The primary transfer roller 5a is press-contacted toward the photosensitive drum 1a side so as to sandwich the intermediary transfer belt 7, so that the primary transfer nip N1 as the primary transfer portion is formed between the photosensitive drum 1a and the intermediary transfer belt 7. The primary transfer roller 5a controls the voltage source by the bias control means 13 of the controller 12, so that a DC voltage of the positive polarity is applied as the primary transfer bias. By this, the toner image which is negatively charged and which is carried on the photosensitive drum 1a is primary-transferred onto the intermediary transfer belt 7 passing through the primary transfer nip N1.

The primary transfer 5a having semiconductivity of 1×10²-10⁸ (Ω) in resistance value when 2000 (V) was applied was used. Specifically, an ion conductive sponge roller, of 6 mm in outer diameter and φ8 mm in core metal diameter, which was formed by blending of a nitrile rubber with an ethylene-epichlorohydrin copolymer was used. The resistance value of the primary transfer roller 5a is about 1×10⁶-10⁸ (Ω) when an applied voltage is 2 (KV) under an environment of a temperature of 23° C and a humidity of 50% RH.

The photosensitive member cleaner 6a removes a transfer residual toner deposited on the surface of the photosensitive drum 1a passing through the primary transfer nip N1 by rubbing the photosensitive drum 1a with a cleaning blade.

Next, at the secondary transfer nip (secondary transfer portion) N2, the outer secondary transfer roller 8 is urged at both end portions with respect to an axial direction by a spring member (not shown in the figure), and is press-contacted toward the inner secondary transfer roller 15 via the intermediary transfer belt 7 with a force of 6.5 mgf (≈63.74 N). By this, the secondary transfer nip N2 is formed between the intermediary transfer belt 7 and the inner secondary transfer roller 15. The inner secondary transfer roller 15 is connected with a ground potential.

The controller 12 controls a transfer output for applying a voltage to the outer secondary transfer roller 8, so that during image formation, the secondary transfer bias is applied from the bias control means 13 to the outer secondary transfer roller 8. In other words, the bias control means 13 applies the secondary transfer bias to between the inner secondary transfer roller 15 and the outer secondary transfer roller 8. By this, the toner image which is negatively charged and which is carried on the intermediary transfer belt 7. The secondary transfer bias is set by applying a voltage to the outer secondary transfer roller in advance of image formation immediately before the recording material P reaches the secondary transfer nip N2 during normal image formation.

In this embodiment, the controller 12 applies the secondary transfer bias at timing of start of the exposure of the exposure device (exposure means) 3a in the above-described first mode (FIG. 7). Further, the controller 12 can effect control so that the secondary transfer bias is applied before the fog toner carried on the photosensitive drums 1a-1d during application of the developing bias to the developing devices 4a-4d reaches the primary transfer nip (primary transfer position) N1 in the first mode.

By these, in this embodiment in which the inner secondary transfer roller 15 opposing the outer secondary transfer roller 8 is a rotatable driving member, even in the case where the sheet interval G exceeds the interval during normal (sheet interval) and increases, it becomes possible to effectively prevent generation of the color misregistration or the like. Here, “interval during normal (sheet interval)” of the sheet interval G is an interval corresponding to a distance of 30 mm or less or a time of 150 msec or less with respect to the A4-sized recording material during continuous print.

For the intermediary transfer belt 7, a semiconductive polyimide resin (material) having dielectric constant ε=3-5 and volume resistivity ρv=1×10⁶-10¹¹ (Ω·cm) is used.

The inner secondary transfer roller 15 also functions as the driving roller for driving the intermediary transfer belt 7 in order to reduce the number of times of use of the rubber roller high is cost while realizing a small diameter of the roller for stretching the intermediary transfer belt 7 for downsizing and cost reduction.

The inner secondary transfer roller 15 employing the small-diameter roller for downsizing is, for example, 13 (mm) in diameter. As a rubber material for a surface layer, a semiconductor rubber of, for example, 0.5 (mm) in thickness in which electroconductive carbon (black) is dispersed in EPDM rubber is used. The resistance value of the inner secondary transfer roller 15 is about 1×10¹-10⁵ (Ω) when an applied voltage is 10 V in an environment of a temperature of 23° C. and a humidity of 50% RH.

As the outer secondary transfer roller 8, an ion conductive sponge roller, of φ18 mm in outer diameter and φ10 mm in core metal diameter, which is formed toy blending a nitrile rubber with an ethylene-epichlorohydrin copolymer is used. The resistance value of the outer secondary transfer roller 8 is about 1×10⁶-10⁸ (Ω) when an applied voltage is 2 (kV) in an environment of a temperature of 23° C. and a humidity of 50% RH by the above-described measuring method.

A feature of the roller using the ion conductive material is that compared with an electron conductive roller using carbon black as an electroconductive material, a dispersing property of the material is good and manufacturing variation in resistance value can be suppressed and the roller can be prepared relatively inexpensively. However, the resistance value varies depending on the environment. For example, the resistance value varies by two digits between the environment of 23° C./5% and the environment of 30° C./80%. Further, there are features such that a change in polarity of the ion conductive material occurs by energization and the resistance value increases.

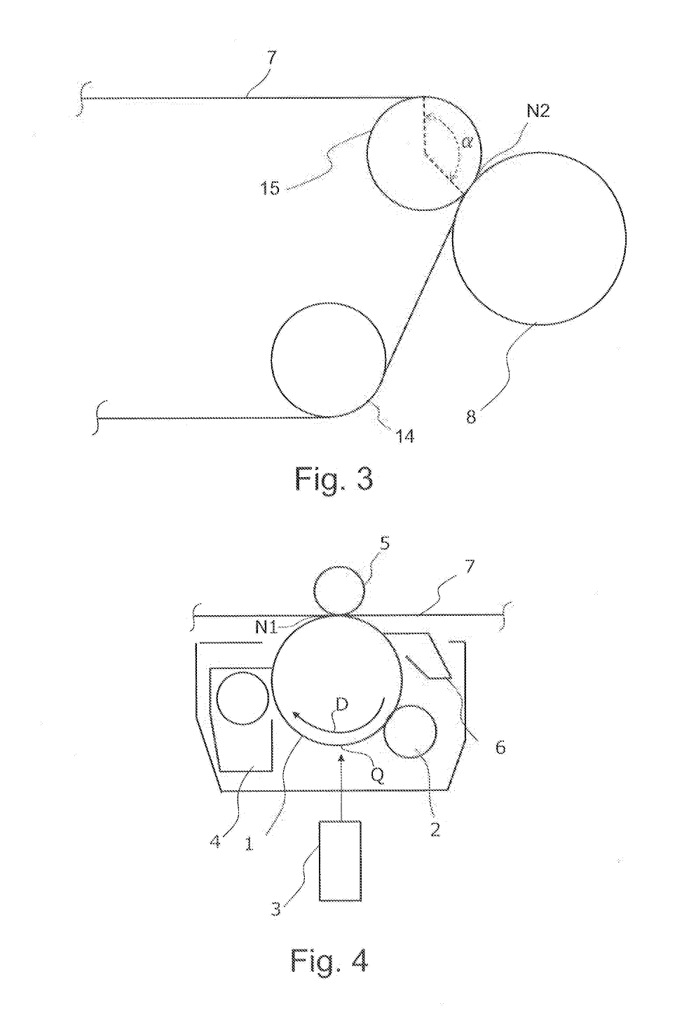

Here, referring to FIG. 3, a degree of a winding angle (winding angle) between the intermediary transfer belt 7 and the inner secondary transfer roller (driving roller) 15 will be described.

That is, as shown in FIG. 3, a winding angle α between the intermediary transfer belt 7 and the inner secondary transfer roller 15 is 123 deg. which is small since the small-diameter roller is used as the inner secondary transfer roller 15.

Further, a process speed in this embodiment is, for example, 200 mm/sec and is set so that a speed of the intermediary transfer belt 7 is 200 mm/sec, for example. A relative speed between moving speeds of the intermediary transfer belt 7 and the photosensitive drum 1a is set so that the speed of the intermediary transfer belt 7 is faster than the speed of the photosensitive drum 1a by 0.5% as a center value.

A speed tolerance is within ±0.5% and even at a lower limit of the tolerance, the speed of the intermediary transfer belt 7 is always made faster, so that progress of a void is prevented. This is for preventing the tolerance from varying over a range including 0 in view of the color misregistration, and a one-side tolerance is provided and the speed difference is brought near to 0 to the possible extent for the countermeasure against the void.

### PTVC Control

Next, the PTVC control used in this embodiment will be described. That is, in order to transfer the toner images formed on the oil the photosensitive drums 1a-1d onto the intermediary transfer belt 7 by the primary transfer rollers 5a-5d, to the primary transfer rollers 5a-5d, a voltage is applied in advance of image formation. Then, the PTVC control in which by the transfer current detecting means 18 of the controller 12, a current flowing through the primary transfer nips N1 is detected and a voltage condition used during primary transfer is set is effected.

Thus, by the PTVC control, the controller 12 is capable of properly setting a constant-voltage value used during the image formation by measuring values of currents flowing through the primary transfer rollers 5a-5d under application of constant voltages of a plurality of levels to the primary transfer rollers 5a-5d before the image formation.

### Countermeasure Sequence

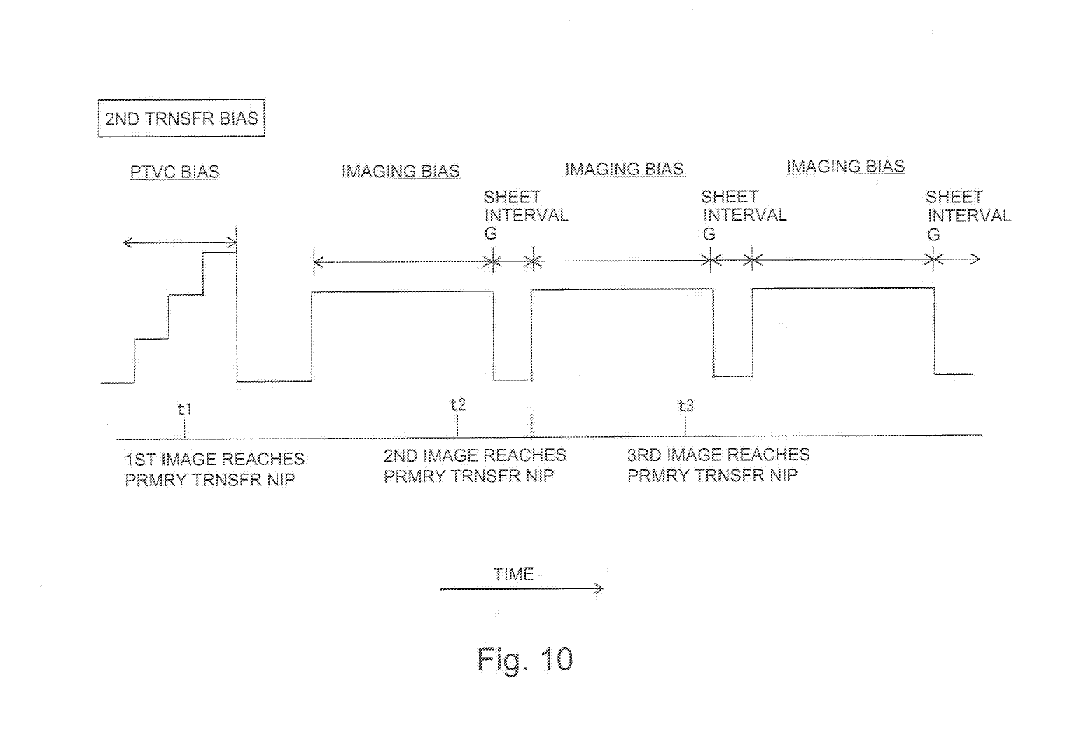

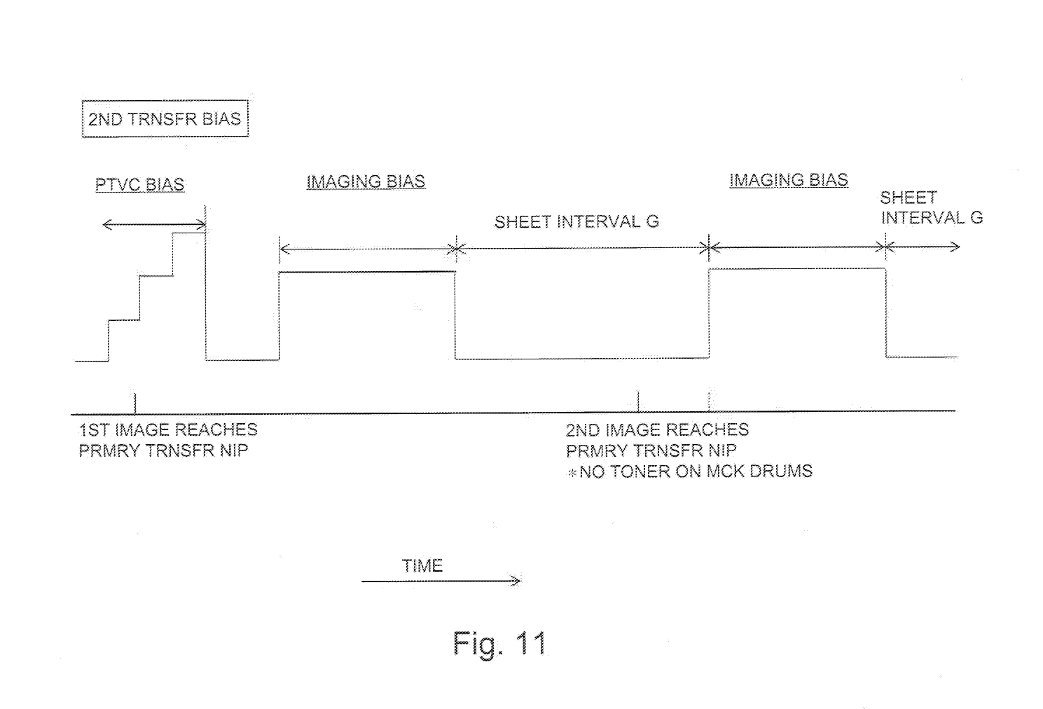

Here, referring to FIG. 10, a countermeasure sequence against the color misregistration or the like will be described.

That is, as shown in FIG. 10, during the normal image formation, the PTVC control is effected in pre-rotation performed before the image formation. For that reason, at timing (t1) when the toner image (image) of Y which is a first color corresponding to a first sheet of the recording material reaches the primary transfer nip N1, the secondary transfer bias as an image forming bias is applied to the outer secondary transfer roller 8. Further, also at timing (t2) when the toner image of Y which is the first color corresponding to a second sheet reaches the primary transfer nip N1, the secondary transfer bias as the image forming bias is applied to the outer secondary transfer roller 8. Further, also at timing (t3) when the toner image of Y which is the first color corresponding to a third sheet reaches the primary transfer nip N1, the secondary transfer bias as the image forming bias is applied to the outer secondary transfer roller 8.

As described above, in the case where the sheet interval G between continuously fed recording materials is proper, between the inner secondary transfer roller 15 which is the opposite roller to the outer secondary transfer roller 8 and the intermediary transfer belt 7, the frictional force generates by the electrostatic attraction force. By this, even in the case where the inner secondary transfer roller 15 is lowered in surface friction coefficient due to contamination with the toner or the like by repetition of image formation (endurance), the color misregistration is prevented from generating.

Here, the outer secondary transfer roller 8 is the roller using the ion conductive material, and therefore during the sheet interval during continuous sheet passing, the controller 12 turns off the secondary transfer bias in order to suppress the increase in resistance value and turns on the secondary transfer bias immediately before the recording material P (the toner image formed by the exposure) reaches the secondary transfer nip N2.

In the case where the condition is not in a specific condition such as during sheet passing of a small-sized recording material (small-sized paper), adjustment of the image by the image forming apparatus 20, and much time required for image processing of a print image as described later, the sheet interval G is short and proper as described above (FIG. 10). For that reason, the secondary transfer bias is applied at the timing when the toner image of Y as the first color reaches the primary transfer nip N1, so that the feeding force of the intermediary transfer belt 7 is ensured by the attraction force by the secondary transfer bias, and therefore the color misregistration does not generate. Further, at the sheet interval G during the continuous sheet passing, the respective toner images exist on the photosensitive drums for the second color and later, and therefore the toner particles function as the friction-lowering agent, so that the frictional force becomes small and the color misregistration does not readily generate.

Here, the countermeasure sequence against the color misregistration in this embodiment will be described. Incidentally, in the following description, a, b, c, d added to the photosensitive drums 1a-1d and the like are removed as needed, and the photosensitive drums 1a-1d and the like will be referred to as the photosensitive drum 1 and the like as a general term.

During the continuous print or the like, the sheet interval G largely increases in some instances in the cases of during generation of downtime for the small-sized paper, adjustment of the image by the image forming apparatus 20, much time required for image processing of the print image, and the like. At this time, according to conventional control, the timing when the secondary transfer bias turned off during the sheet interval is turned on subsequently is immediately before the recording material reaches the secondary transfer nip N2. For that reason, at timing when the toner image of Y as the first color reaches the primary transfer nip N1, the secondary transfer bias has not been turned on yet.

Further, the toner images of the second color and later have already passed through the photosensitive drums, and therefore there are no toner particles as the friction-lowering agent on the photosensitive drums 1, so that the attraction force, by the secondary transfer bias, between the intermediary transfer belt 7 and the photosensitive drums 1 becomes high. For this reason, the intermediary transfer belt 7 follows the speed of the photosensitive drum 1, not the speed of the inner secondary transfer roller 15. For that reason, when the toner image, of Y as the first color, for a subsequent image reaches the primary transfer nip N1, the attraction force between the intermediary transfer belt 7 and the photosensitive drum 1 lowers, so that there is a possibility that the color misregistration generates. With respect to the toner image of Y as the first color at this time, the fog toner generating when an AC bias is applied to the toner image performs the function of weakening the attraction force between the intermediary transfer belt 7 and the photosensitive drum 1. For that reason, there is a possibility that the color misregistration generates at timing when the fog toner reaches the primary transfer nip N1.

In the countermeasure sequence in this embodiment, in the case where the sheet interval G increases and there is no toner image as the friction-lowering agent on the photosensitive drums 1 for the second color and later, control is effected by the controller 12 in the following manner. That is, a trigger for subsequent turning-on of the secondary transfer bias turned off at the sheet interval G is set so as to coincide with timing when writing of the electrostatic latent image on the photosensitive drum 1 is started in order that the secondary transfer bias is turned on before the toner image of Y as the first color reaches the primary transfer nip N1. That is, in the above-described first mode, the controller 12 effects control so that the secondary transfer bias is applied at timing of start of the exposure by the exposure device 3 (see FIG. 7).

The secondary transfer bias at this time may desirably be turned on until the fog toner, generating by turning on a developing bias (developing AC) applied to the developing device 4, reaches the primary transfer nip N1. That is, in the first mode, the controller 12 is capable of applying the secondary transfer bias before the fog toner, formed on the photosensitive drum 1 during application of the developing bias to the developing device 4, reaches the primary transfer nip N1. In this case, it is possible to effectively prevent generation of the color misregistration.

Here, in this embodiment, as shown in FIG. 4, a writing position Q of the image (electrostatic latent image) on the photosensitive drum and the primary transfer nip N1 are in substantially 180 deg. opposite positions. In this embodiment, as the photosensitive drum 1, a drum of φ30 mm, for example, in diameter is used, and therefore it takes about 235 msec from the writing position Q of the image to the primary transfer nip N1. Then, the high voltage rises in approximately 100 msec, and therefore the time is sufficiently in time until the fog toner reaches the primary transfer nip N1.

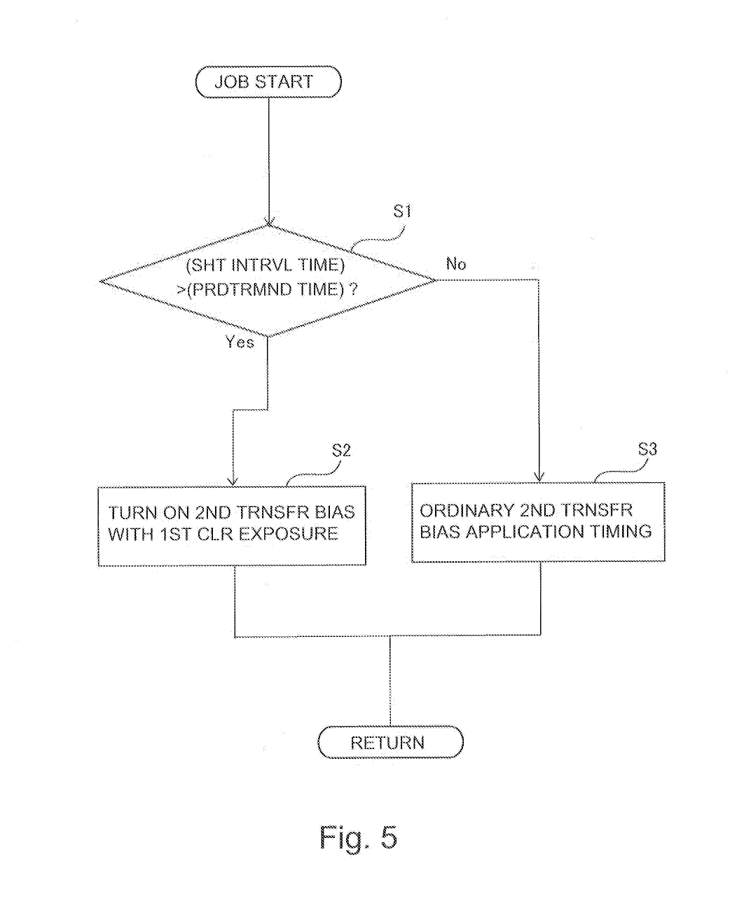

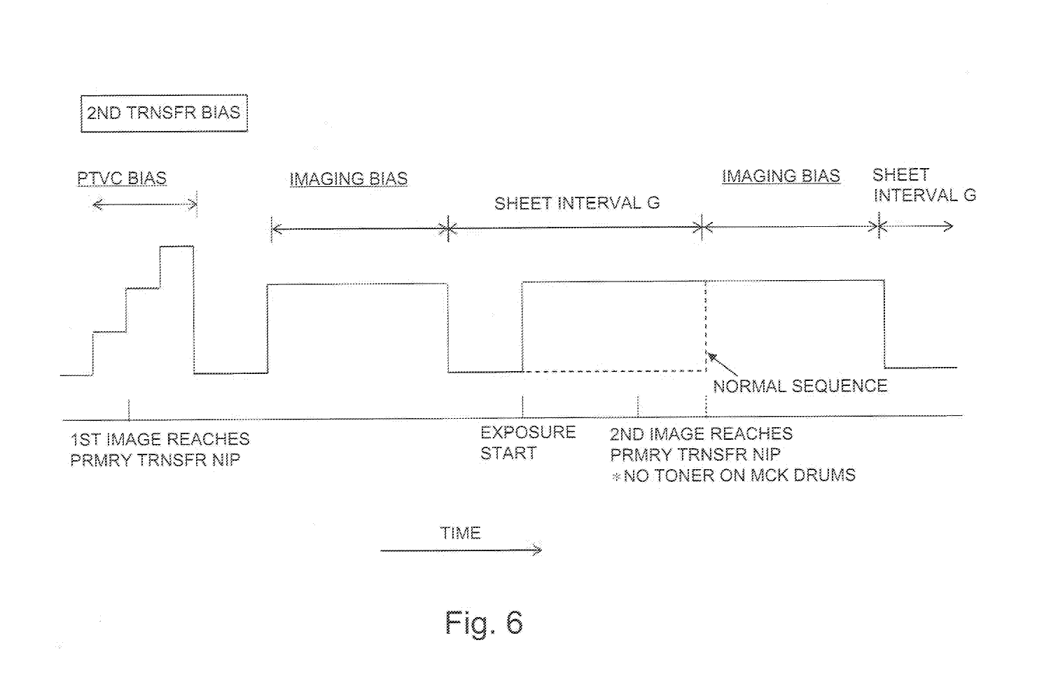

Next, the action of this embodiment will be described with reference to FIG. 5-FIG. 7. Incidentally, FIG. 5 is a flowchart for illustrating the action in this embodiment, FIG. 6 is a time chart showing a state of a sheet interval during the image formation, and FIG. 7 is a time chart showing application timing of the secondary transfer bias.

First, from start of JOB (job), image formation of a first sheet is effected. Thereafter, the controller 12 discriminates, during the continuous sheet passing, whether or not a time corresponding to the sheet interval G exceeds a predetermined time and elapses from start of image writing by the exposure device 3a for the first color to start of the writing of the exposure device 3a for a subsequent first color (step S1).

As a result thereof, in the case where the controller 12 discriminates that the time corresponding to the sheet interval G is a first interval within the predetermined time (step S1: No), the controller 12 executes the second mode (step S3). Here, the first interval which is the interval during normal (sheet interval) is an interval corresponding to 30 mm or less in distance or 150 msec or less in time with respect to the A4-sized recording material during the continuous print. In the second mode, when the sheet interval G of the recording materials fed to the secondary transfer nip N2 is the first interval within the predetermined time, the trigger for turning-on of the secondary transfer bias for subsequent image formation is turned on at normal application timing (predetermined timing) of the secondary transfer bias.

On the other hand, in the step S1, the controller 12 executes the first mode in the case where the controller 12 discriminates that the time corresponding to the sheet interval exceeds the predetermined time (step S1: Yes). In the first mode, when the sheet interval is a sheet interval G2 (FIG. 7) longer than a first sheet interval G1 (FIG. 7), the controller 12 effects control so as to shift the predetermined timing so that the secondary transfer bias is applied before the toner image on the photosensitive drum 1a reaches the primary transfer nip N1. The above second interval means an interval the secondary transfer bias is applied after the toner image on the photosensitive drum reaches the primary transfer nip N1 when the secondary transfer bias is applied at the predetermined timing. In order to realize this, the controller 12 effects control so that the secondary transfer bias is turned on simultaneously with the start of the exposure of the exposure device 3a for the first color (step S2).

Here, the interval of each of the photosensitive drums 1a-1d for the respective colors in this image forming apparatus 20 is 85 mm. Further, a time necessary to move the intermediary transfer belt 7 from the primary transfer nip N1 of the photosensitive drum 1a for the first color to the primary transfer nip N1 of the photosensitive drum 1d for a fourth color is 1.27 sec. For that reason, in the case where 1.27 sec or more elapses from start of image writing by the exposure device 3a for the first color to start of the writing by the exposure device 3a for a subsequent first color, the operation is performed in the following manner. That is, a trigger for turning-on of the secondary transfer bias for subsequent image formation is caused to coincide with image writing start timing by the exposure device 3a for the first color.

At this time, image writing timing of the exposure device 3a and turning-on timing of the secondary transfer bias are shown in FIG. 7. In FIG. 7, an exposure signal transferring from OFF state to ON state is shown on an upper stage, and the secondary transfer bias is shown on a lower stage.

At the sheet interval G1 corresponding to the first interval, at timing when the toner image of Y as the first color reaches the primary transfer nip N1, the secondary transfer bias is applied to the outer secondary transfer roller 8 by the controller 12. On the other hand, at the sheet interval G2 corresponding to the second interval, at the timing when the toner image of Y as the first color reaches the primary transfer nip N1, there is a high possibility that a state in which the secondary transfer bias is not applied to the outer secondary transfer roller 8 is invited. For this reason, the controller 12 effects control so that the secondary transfer bias is turned on simultaneously with start of exposure of the exposure device 3a for the first color.

As described above, according to this embodiment, the frictional force by the electrostatic attraction force is always generated between the inner secondary transfer roller 15 and the intermediary transfer belt 7, even in the case where the surface friction coefficient of the inner secondary transfer roller 15 lowers due to the contamination with the toner or the like, it is possible to prevent generation of the color misregistration. Incidentally, OFF timing of the secondary transfer bias corresponding to the sheet interval G2 is similar to the case where the sheet interval is the short sheet interval G1.

Further, in the case where the sheet interval increases during the continuous sheet passing and the toner images of the second color and later pass through the respective photosensitive drums and thus there are no toner particles and the attraction force between the intermediary transfer belt 7 and the photosensitive drums 1 enhances and the feeding force of the intermediary transfer belt 7 by the inner secondary transfer roller 15 lowers, the constitution is as follows. That is, a constitution in which at the timing when the toner image of Y as the first color reaches the primary transfer nip N1, the secondary transfer bias is applied to the outer secondary transfer roller 8 is employed. By this, it is possible to prevent generation of the color misregistration.

In this embodiment described above, in the case where the sheet interval increases, the trigger for the turning-on of the secondary transfer bias for the subsequent image by the controller 12 is timing which coincides with the image writing start by the exposure device 3. However, due to an outer diameter of the photosensitive drum 1, arrangement of the exposure device 3, or a rise time of the secondary transfer bias or the like, even when the trigger is changed to another trigger, a similar effect can foe obtained if the secondary transfer bias is turned on before the fog toner by the toner image of Y as the first color reaches the primary transfer nip N1.

### Secondary Embodiment

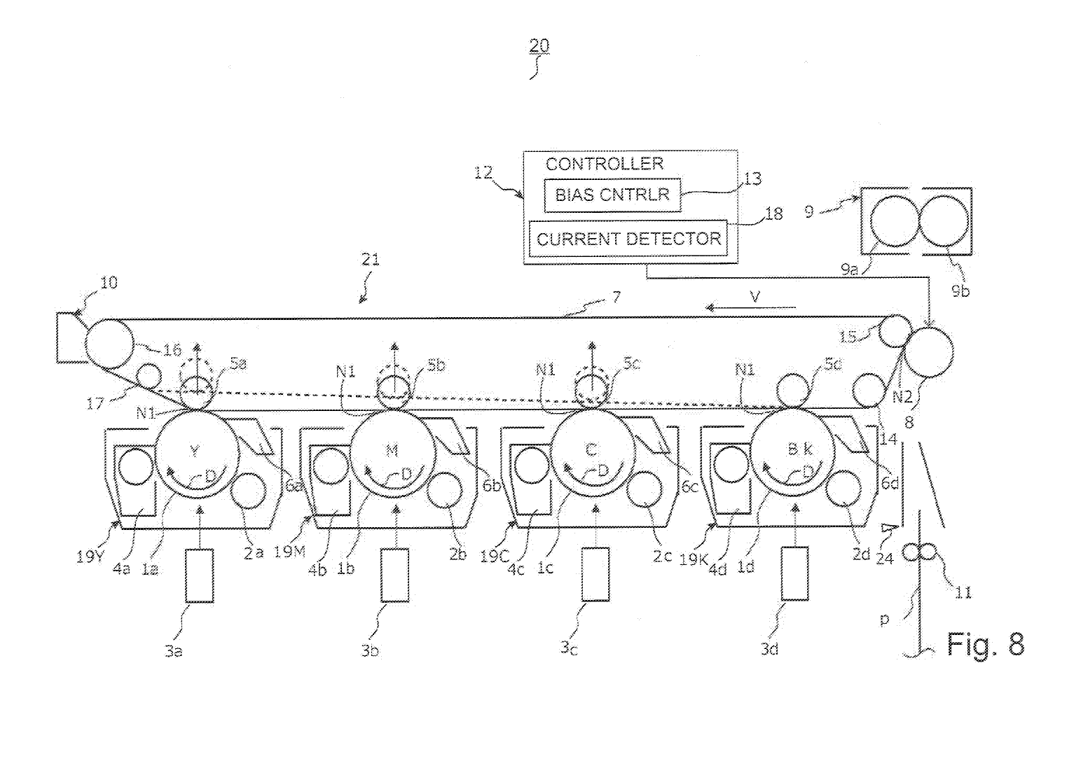

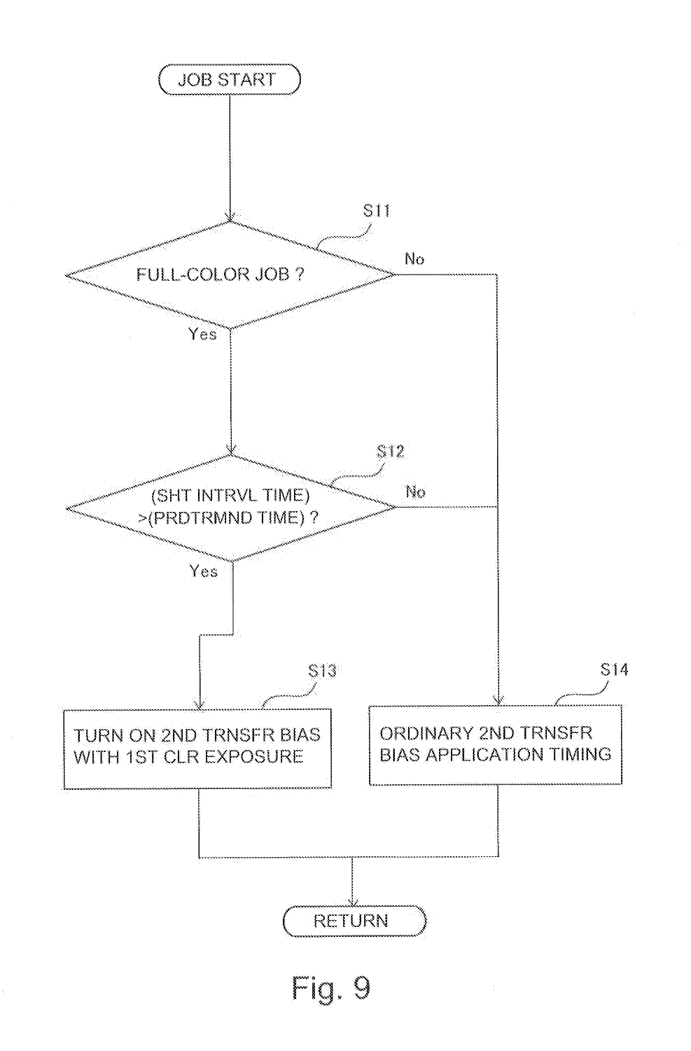

Next, with reference to FIG. 8 and FIG. 9, Second Embodiment according to the present invention will be described. FIG. 8 is a schematic sectional view showing a part of an image forming apparatus 20 in this embodiment, and FIG. 9 is a flowchart for illustrating the action in this embodiment. Incidentally, a constitution of the image forming apparatus 20 is similar to the constitution in First Embodiment, and therefore in this Second Embodiment, constituent elements common to First Embodiment and Second Embodiment are represented by the same symbols and will be omitted from description thereof.

The image forming apparatus 20 in this embodiment is similar in basic operation to the image forming apparatus 20 in First Embodiment. However, this image forming apparatus 20 is constituted so that in the image forming apparatus 20 in First Embodiment, a full-color mode in which the image forming units (the image forming portions 19Y-19K) for all of the colors are caused to function and a Bk monochromatic (single color) mode in which only the image forming unit for Bk is caused to function are selectable.

That is, in this embodiment, a plurality (specifically 4) of the photosensitive drums (image bearing members) 1a-1d are provided along a rotational direction (arrow V direction) of the intermediary transfer belt 7. Further, the controller (control means) 12 is, as described above, constituted so as to be capable of executing the full-color mode in which the image formation is effected using all of the photosensitive drums 1a-1d and the Bk monochromatic mode (single-color mode).

The controller 12 effects control in which the application of the secondary transfer bias is started between from start of the exposure of the most upstream photosensitive drum 1a, of the photosensitive drums 1a-1d with respect to the rotational direction, to light by the exposure device 3a to before the toner image formed by this exposure reaches the primary transfer nip N1. That is, the controller 12 applies, via the bias control means 13, the secondary transfer bias before the toner image on the most upstream photosensitive drum la reaches the primary transfer nip N1 during the full-color mode. Incidentally, the constitution in this embodiment is also applicable to First Embodiment described above.

In the intermediary transfer tandem type having the constitution in which the mode is switchable as described above, the photosensitive drums of the image forming units which are caused not to function during the image formation in the Bk monochromatic mode are spaced from the intermediary transfer belt 7, so that abrasion (wearing) and damage (scars) of the photosensitive drums are prevented and thus it becomes possible to prolong a photosensitive drum lifetime.

As shown in FIG. 8, in the linage forming apparatus 20 capable of switching the full-color mode and the Bk monochromatic mode, with respect to the primary transfer rollers, the primary transfer rollers 5a, 5b, 5c for the full-color station are constituted so as to move toward and away from the intermediary transfer belt 7. These primary transfer rollers 5a, 5b, 5c are subjected to a spacing operation by an unshown contact and separation mechanism corresponding to the image forming mode.

In FIG. 8, a solid line shows a pressed state of the primary transfer nips 5a, 5b, 5c during the full-color mode, and a broken line shows a spaced state of the primary transfer nips 5a, 5b, 5c in the Bk monochromatic mode. Thus, depending on the image forming mode, contact and separation states can be smoothly switched by spacing the primary transfer rollers 5a, 5b, 5c from the photosensitive drums 1a, 1b, 1c, respectively, via the intermediary transfer belt 7.

In the image forming apparatus to in this embodiment, during a rest such as during stand-by of image formation, the image forming apparatus 20 is in stand-by in the Bk monochromatic mode in which the primary transfer rollers 5a, 5b, 5c are spaced. Depending on the image forming mode, in the case where for example, the full-color mode is selected, a contacting operation of the primary transfer rollers 5a, 5b, 5c, from the Bk monochromatic mode during the stand-by to the full-color mode is performed. Thereafter full-color image formation is effected, and at the time of an end of the image formation, the image forming mode is returned to the Bk monochromatic mode by the spacing operation of the primary transfer rollers, so that the image forming apparatus 20 assumes the stand-by state.

### Countermeasure Sequence

A sequence operation in this embodiment is basically similar to the sequence operation in First Embodiment.

First, after JOB (job) is started, the controller 12 discriminates whether or not the full-color mode is selected as the image forming mode (step, S11). As a result thereof, when the Bk monochromatic mode, not the full-color mode is selected (step S11: No), the operation goes to step S14, and when the full-color mode is selected (step S11: Yes), the operation goes to step S12.

In the step S14, the controller 12 executes the second mode, and effects control in which the trigger for turning-on of the secondary transfer bias for subsequent image formation is turned on according to normal timing when the sheet interval G of the recording materials fed to the secondary transfer nips N2 is the first interval within the predetermined time.

On the other hand, in the step S12, after image formation of a first sheet is effected, the controller 12 discriminates, during the continuous sheet passing, whether or not a time corresponding to the sheet interval G exceeds a predetermined time and elapses from start of image writing by the exposure device 3a for the first color to start of the writing of the exposure device 3a for a subsequent first color (step S1).

As result thereof, in the case where the controller 12 discriminates that the time corresponding to the sheet interval G is a first interval within the predetermined time (step S12: No), the operation goes to the step S14, and the controller effects control so that the secondary transfer bias is turned on at normal secondary transfer bias application timing. On the other hand, in the step S1, the controller 12 executes the first mode via the bias control means 13 in the case where the controller 12 discriminates that the time corresponding to the sheet interval G exceeds the predetermined time (step S12: Yes). This is, before the toner image on the photosensitive drum 1a reaches the primary transfer nip N1, the controller 12 effects control so as to shift the predetermined timing so that the secondary transfer bias is applied to the outer secondary transfer roller 8. That is, the controller 12 effects control so that the secondary transfer bias is turned on simultaneously with the start of the exposure of the exposure device 3a for the first color (step S13).

As described above, in this embodiment, attention is paid to that the color misregistration does not generate in the Bk monochromatic mode, and the controller 12 effects control so that the controller 12 discriminates whether the image forming mode is the full-color mode or the Bk monochromatic mode and then the operation mode goes to the first mode or the second mode. That is, in this embodiment, during the full-color mode, even in the case where the sheet interval increases during the continuous sheet passing and the toner images of the second color and later pass through the respective photosensitive drums and thus there are no toner particles and the attraction force between the intermediary transfer belt 7 and the photosensitive drums 1 is liable to enhance, the following operation can be performed. That is, even in the case where the feeding force of the intermediary transfer belt 7 by the inner secondary transfer roller 15 lowers, at the timing when the toner image of Y as the first color reaches the primary transfer nip N1, the secondary transfer bias is applied, and therefore, it is possible to prevent generation of the color misregistration.

### INDUSTRIAL APPLICABILITY

According to the present invention, there is provided an image forming apparatus in which generation of the color misregistration was prevented.

1. An image forming apparatus comprising:
a photosensitive member rotationally moving at a predetermined peripheral speed;
an exposure unit for forming a latent image by subjecting said photosensitive member electrically charged to image exposure on the basis of an image signal;
a developing unit for depositing a toner image on the latent image formed on said photosensitive member;
an intermediary transfer belt, moving at a different peripheral speed from said photosensitive member, onto which the toner image on said photosensitive member is once transferred at a primary transfer portion contacting said photosensitive member;
a transfer member for transferring the toner image, transferred on said intermediary transfer belt, onto a recording material at a secondary transfer portion;
a transfer voltage source for applying a secondary transfer bias to the secondary transfer portion; and
a controller for controlling, in a recording material interval from passing of a trailing end of a certain recording material through the secondary transfer portion to passing of a leading end of a subsequent recording material through the secondary transfer portion during execution of continuous image formation, said transfer voltage source so that application of the secondary transfer bias is started at timing of either one of first timing and second timing which are before the application of the secondary transfer bias is stopped or a bias of an opposite polarity to the secondary transfer bias is started after the passing of the trailing end of the certain recording material through the secondary transfer portion and then the leading end of the subsequent recording material reaches the secondary transfer portion,
wherein said controller controls said transfer voltage source every recording material interval at the first timing in a case where a time of the recording material interval is less than a predetermined time and at the second timing in a case where the time of the recording material interval is not less than the predetermined time, and
wherein the first timing is timing immediately before the toner image corresponding to the image exposure reaches the secondary transfer portion, and the second timing is timing from start of the image exposure until the toner image corresponding to the image exposure reaches the primary transfer portion.

2. An image forming apparatus according to claim 1, wherein in the case where the time of the recording material interval is not less than the predetermined time, said controller controls said transfer voltage source so as to start the application of the secondary transfer bias at timing substantially the same as the start of the image exposure.

3. An image forming apparatus according to claim 1, wherein said photosensitive member is provided in a plurality of photosensitive members along a movement direction of said intermediary transfer belt, and
wherein said controller starts the application of the secondary transfer bias in a period from after the image exposure of the photosensitive member, of the plurality of photosensitive members, positioned most upstream with respect to the movement direction is started until the toner image corresponding to the image exposure reaches the primary transfer portion of the photosensitive member position most upstream.

4. An image forming apparatus according to claim 1, comprising a driving roller for stretching said intermediary transfer belt and for imparting a driving force to said intermediary transfer belt,
wherein said driving roller opposes said transfer member via said intermediary transfer belt.

5. An image forming apparatus according to claim 1, wherein the peripheral speed of said intermediary transfer belt is faster than a peripheral speed of said photosensitive member.

6. An image forming apparatus according to claim 1, comprising a voltage source of a developing bias supplied to said developing unit,
wherein said controller controls said transfer voltage source so as to start the application of the secondary transfer bias until a fog toner carried on said photosensitive member reaches the primary transfer portion when application of the developing bias is started in the case where the time of the recording material interval is not less than the predetermined time.
